(19) United States
(12) Patent Application Publication
(10) Pub. No.: US 2025/0310668 A1
(43) Pub. Date: Oct. 2, 2025

(54) SUBMARINE BRANCHING UNIT

(71) Applicant: NEC Corporation, Tokyo (JP)

(72) Inventor: Andre ARASHIRO, Tokyo (JP)

(73) Assignee: NEC Corporation, Tokyo (JP)

(21) Appl. No.: 19/083,666

(22) Filed: Mar. 19, 2025

(30) Foreign Application Priority Data
Apr. 1, 2024 (JP) 2024-058636

(51) Int. Cl. H04Q 11/00; G02B 6/44; H04B 10/25

(52) U.S. Cl. CPC H04Q 11/0005; G02B 6/4427; H04B 10/25; H04Q 2011/0007; H04Q 2011/0058

(57) ABSTRACT

To provide a submarine branching unit that enables interconnection between the trunks of two different systems and allows them to communicate with each other. A submarine branching unit comprising: two first system-side trunk line pairs L1 and L2 that are arranged in parallel between a first trunk and a second trunk; two second system- side trunk line pairs L3 and L4 that are arranged in parallel between a third trunk and a fourth trunk; and an optical switch group configured to switch the connection state between the first system-side trunk line pairs and the second system-side trunk line pairs in accordance with control from a control unit 20.

### INCORPORATION BY REFERENCE

This application is based upon and claims the benefit of priority from Japanese patent application No. 2024-058636, filed on Apr. 1, 2024, the disclosure of which is incorporated herein in its entirety by reference.

### TECHNICAL FIELD

The present disclosure relates to a submarine branching unit.

### BACKGROUND ART

Patent Literature 1 discloses a submarine branching unit that switches between an optical communication path between trunk stations and an optical communication path between a trunk station and a branch station within a single system.

[Patent Literature 1] International Publication No. WO 2020/194842

### SUMMARY

However, in Patent Document 1, there is a problem that the trunks of two different systems cannot be interconnected with each other and cannot communicate.

In view of the problem described above, an example object of the present disclosure is to provide a submarine branching unit that enables interconnection between the trunks of two different systems and allows them to communicate with each other.

A submarine branching unit according an example aspect of the present disclosure includes: two first system-side trunk line pairs that are arranged in parallel between a first trunk and a second trunk; two second system-side trunk line pairs that are arranged in parallel between a third trunk and a fourth trunk; and an optical switch group configured to switch the connection state between the first system-side trunk line pairs and the second system-side trunk line pairs in accordance with control from a control unit.

An example advantage according to the above-described example embodiments is that it is possible to provide a submarine branching unit that enables interconnection between the trunks of two different systems and allows them to communicate with each other.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating an example of a submarine branching unit 1;

FIG. 2 is a diagram showing an example of the submarine branching unit (branching unit) 1;

FIG. 3 is a diagram showing Path 1;

FIG. 4 is a diagram showing Path 2;

FIG. 5 is a diagram showing Path 3;

FIG. 6 is a diagram showing Path 4;

FIG. 7 is a diagram showing Path 5;

FIG. 8 is a diagram showing Path 6;

FIG. 9 is a block diagram illustrating an example of the configuration of computer 1000 according to the present embodiment.

### EXAMPLE EMBODIMENT

The embodiments of the present disclosure will be described in detail below with reference to the drawings. In each figure, the same or corresponding elements are assigned the same reference numerals, and redundant descriptions are omitted as necessary for clarity of explanation.

### First Embodiment

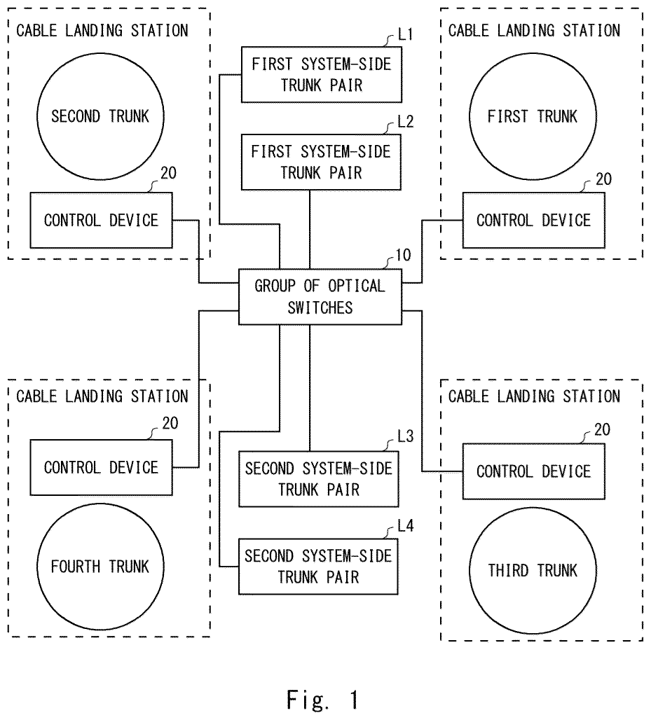

FIG. 1 is a diagram illustrating an example of a submarine branching unit 1.

As shown in FIG. 1, the submarine branching unit 1 according to the first embodiment includes: two first system-side trunk line pairs L1 and L2, which are arranged in parallel between a first trunk and a second trunk; two second system-side trunk line pairs L3 and L4, which are arranged in parallel between a third trunk and a fourth trunk; and an optical switch group 10, which switches the connection state between the first system-side trunk line pairs L1, L2 and the second system-side trunk line pairs L3, L4 in accordance with control from a control unit 20 provided in each cable landing station. The first to fourth trunks are also referred to as trunk stations or terminal stations.

As described above, according to the second embodiment, by controlling the optical switch group in accordance with the control from the control unit 20, it is possible to interconnect the trunks of two different systems (the first system-side trunk line pairs L1 and L2, and the second system-side trunk line pairs L3 and L4) and enable mutual communication.

### Second Embodiment

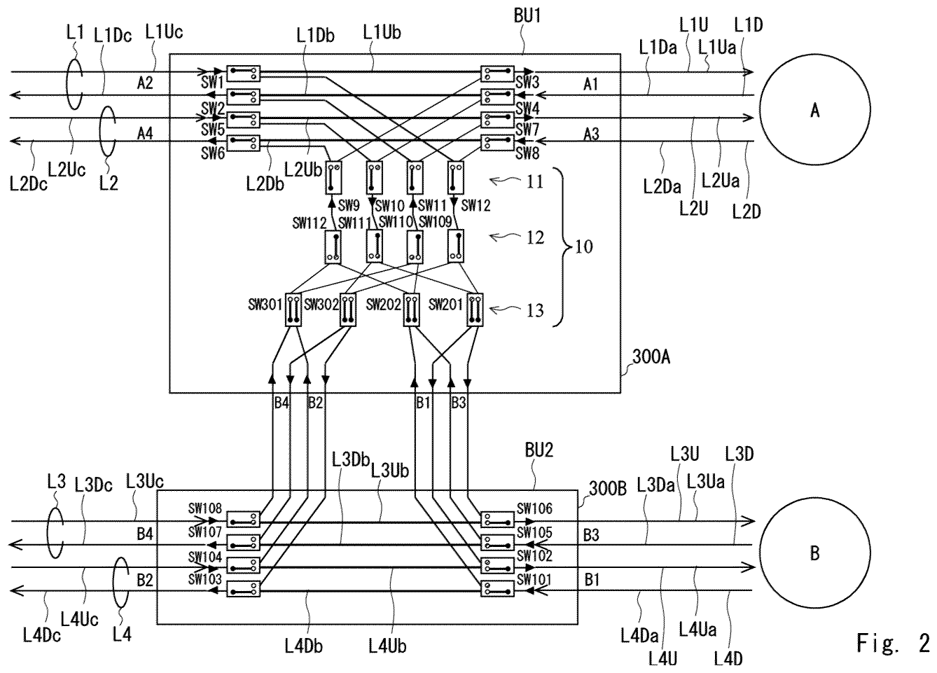

Next, the submarine branching unit (BU) according to the second embodiment will be described with reference to FIG. 2 and subsequent figures. The second embodiment is a more specific implementation of the first embodiment.

FIG. 2 is a diagram showing an example of the submarine branching unit (branching unit) 1.

The submarine branching unit (branching unit) 1 according to the second embodiment is applicable to a submarine cable system. As shown in FIG. 2, the submarine branching unit 1 includes: two first system-side trunk line pairs L1 and L2, which are arranged in parallel between a first trunk A and a second trunk (not shown) facing the first trunk A; two second system-side trunk line pairs L3 and L4, which are arranged in parallel between a third trunk B and a fourth trunk (not shown) facing the third trunk B; and an optical switch group 10, which switches the connection state between the first system-side trunk line pairs L1, L2 and the second system-side trunk line pairs L3, L4.

The two first system-side trunk line pairs L1, L2 and the two second system-side trunk line pairs L3, L4 each have a similar configuration to one another.

First, the configuration of one of the first system-side trunk line pairs L1 will be described.

One of the first system-side trunk line pairs L1 includes a first system-side upstream trunk line L1U and a first system-side downstream trunk line L1D.

The first system-side upstream trunk line L1U includes: a first trunk-side upstream trunk line L1Ua, a first intermediate upstream trunk line L1Ub, a second trunk-side upstream trunk line L1Uc; a first optical switch SW3, which switches the connection between the first trunk-side upstream trunk line L1Ua and either the first intermediate upstream trunk line L1Ub or the optical switch group 10; and a second optical switch SW1, which switches the connection between the second trunk-side upstream trunk line L1Uc and either the first intermediate upstream trunk line L1Ub or the optical switch group 10.

On the other hand, the first system-side downstream trunk line L1D includes: a first trunk-side downstream trunk line L1Da, a first intermediate downstream trunk line L1Db, a second trunk-side downstream trunk line L1Dc; a third optical switch SW4, which switches the connection between the first trunk-side downstream trunk line L1Da and either the first intermediate downstream trunk line L1Db or the optical switch group 10; and a fourth optical switch SW2, which switches the connection between the second trunk-side downstream trunk line L1Dc and either the first intermediate downstream trunk line L1Db or the optical switch group 10.

Next, the configuration of the other first system-side trunk line pair L2 will be described.

The other first system-side trunk line pair L2, includes a first system-side upstream trunk line L2U and a first system-side downstream trunk line L2D.

The first system-side upstream trunk line L2U includes: a first trunk-side upstream trunk line L2Ua, a first intermediate upstream trunk line L2Ub, a second trunk-side upstream trunk line L2Uc; a first optical switch SW7, which switches the connection between the first trunk-side upstream trunk line L2Ua and either the first intermediate upstream trunk line L2Ub or the optical switch group 10; and a second optical switch SW5, which switches the connection between the second trunk-side upstream trunk line L2Uc and either the first intermediate upstream trunk line L2Ub or the optical switch group 10.

On the other hand, the first system-side downstream trunk line L2D includes: a first trunk-side downstream trunk line L2Da, a first intermediate downstream trunk line L2Db, a second trunk-side downstream trunk line L2Dc; a third optical switch SW8, which switches the connection between the first trunk-side downstream trunk line L2Da and either the first intermediate downstream trunk line L2Db or the optical switch group 10; and a fourth optical switch SW6, which switches the connection between the second trunk-side downstream trunk line L2Dc and either the first intermediate downstream trunk line L2Db or the optical switch group 10.

Next, the configuration of one of the second system-side trunk line pairs L3 will be described.

One of the second system-side trunk line pairs L3 includes a second system-side upstream trunk line L3U and a second system-side downstream trunk line L3D.

The second system-side upstream trunk line L3U includes: a third trunk-side upstream trunk line L3Ua, a second intermediate upstream trunk line L3Ub, a fourth trunk-side upstream trunk line L3Uc; a fifth optical switch SW106, which switches the connection between the third trunk-side upstream trunk line L3Ua and either the second intermediate upstream trunk line L3Ub or the optical switch group 10; and a sixth optical switch SW108, which switches the connection between the fourth trunk-side upstream trunk line L3Uc and either the second intermediate upstream trunk line L3Ub or the optical switch group 10.

On the other hand, the second system-side downstream trunk line L3D includes: a third trunk-side downstream trunk line L3Da, a second intermediate downstream trunk line L3Db, a fourth trunk-side downstream trunk line L3Dc; a seventh optical switch SW105, which switches the connection between the third trunk-side downstream trunk line L3Da and either the second intermediate downstream trunk line L3Db or the optical switch group 10; and an eighth optical switch SW107, which switches the connection between the fourth trunk-side downstream trunk line L3Dc and either the second intermediate downstream trunk line L3Db or the optical switch group 10.

Next, the configuration of the other second system-side trunk line pair L4 will be described.

The other second system-side trunk line pair L4 includes a second system-side upstream trunk line L4U and a second system-side downstream trunk line L4D.

The second system-side upstream trunk line L4U includes: a third trunk-side upstream trunk line L4Ua, a second intermediate upstream trunk line L4Ub, a fourth trunk-side upstream trunk line L4Uc; a fifth optical switch SW102, which switches the connection between the third trunk-side upstream trunk line L4Ua and either the second intermediate upstream trunk line L4Ub or the optical switch group 10; and a sixth optical switch SW104, which switches the connection between the fourth trunk-side upstream trunk line L4Uc and either the second intermediate upstream trunk line L4Ub or the optical switch group 10.

On the other hand, the second system-side downstream trunk line L4D includes: a third trunk-side downstream trunk line L4Da, a second intermediate downstream trunk line L4Db, a fourth trunk-side downstream trunk line L4Dc; a seventh optical switch SW101, which switches the connection between the third trunk-side downstream trunk line L4Da and either the second intermediate downstream trunk line L4Db or the optical switch group 10; and an eighth optical switch SW103, which switches the connection between the fourth trunk-side downstream trunk line L4Dc and either the second intermediate downstream trunk line L4Db or the optical switch group 10.

Next, the first to eighth optical switches will be described.

The first to eighth optical switches are each 1×2 optical switches. Specifically, the first optical switches (SW3, SW7), the fourth optical switches (SW2, SW6), the fifth optical switches (SW106, SW102), and the eighth optical switches (SW107, SW103) are each optical switches with two inputs (input ports) and one output (output port). These switches are controlled by a control unit (not shown) and switch the connection between one of the two inputs and the single output. The first optical switches (SW3, SW7), the fourth optical switches (SW2, SW6), the fifth optical switches (SW106, SW102), and the eighth optical switches (SW107, SW103) may be any known optical switch with two input ports and one output port.

On the other hand, the second optical switches (SW1, SW5), the third optical switches (SW4, SW8), the sixth optical switches (SW108, SW104), and the seventh optical switches (SW105, SW101) are each optical switches with one input (input port) and two outputs (output ports). These switches are controlled by a control unit and switch the connection between the one input and either of the two outputs. The second optical switches (SW1, SW5), the third optical switches (SW4, SW8), the sixth optical switches (SW108, SW104), and the seventh optical switches (SW105, SW101) may be any known optical switch with one input port and two output ports.

Next, the optical switch group 10 will be described.

The optical switch group 10 includes a first optical switch group 11, a second optical switch group 12, and a third optical switch group 13, which are arranged in parallel.

The first optical switch group 11 consists of optical switches SW9 to SW12. The second optical switch group 12 consists of optical switches SW109 to SW112. The third optical switch group 13 consists of optical switches SW201, SW202, SW301, and SW302.

The optical switches SW9 to SW12, which constitute the first optical switch group 11, and the optical switches SW109 to SW112, which constitute the second optical switch group 12, are each 1×2 optical switches.

Specifically, the optical switches SW10, SW12, SW110, and SW112 are each optical switches with two inputs (input ports) and one output (output port). These switches are controlled by a control unit and switch the connection between one of the two inputs and the single output. The optical switches SW10, SW12, SW110, and SW112 may be any known optical switches with two input ports and one output port.

On the other hand, the optical switches SW9, SW11, SW109, and SW111 are each optical switches with one input (input port) and two outputs (output ports). These switches are controlled by a control unit and switch the connection between the one input and either of the two outputs. The optical switches SW9, SW11, SW109, and SW111 may be any known optical switches with one input port and two output ports.

The optical switches SW201, SW202, SW301, and SW302, which constitute the third optical switch group 13, are each 2×2 optical switches.

Specifically, the optical switches SW201, SW202, SW301, and SW302, which constitute the third optical switch group 13, are each optical switches with two inputs (input ports) and two outputs (output ports). These switches are controlled by a control unit and switch the connection between one of the two inputs and one of the two outputs. The optical switches SW201, SW202, SW301, and SW302, which constitute the third optical switch group 13, may be any known optical switches with two input ports and two output ports.

The first to eighth optical switches and each optical switch constituting the optical switch group 10 are connected as shown in FIG. 2.

For example, the first trunk-side upstream trunk line L1Ua is connected to the output of the first optical switch SW3. On the other hand, one of the inputs of the first optical switch SW3 is connected to one of the outputs of the second optical switch SW1. Additionally, the other input of the first optical switch SW3 is connected to one of the outputs of the optical switch SW9. The same applies to the other first to fourth optical switches.

On the other hand, one of the outputs of the optical switch SW9, which constitutes the first optical switch group 11, is connected to the other input of the first optical switch SW3. Meanwhile, the other output of the optical switch SW9 is connected to one of the inputs of the fourth optical switch SW6.

The same applies to the other optical switches SW10 to SW12, which constitute the first optical switch group 11.

Additionally, the input of the optical switch SW109, which constitutes the second optical switch group 12, is connected to the output of the optical switch SW12. On the other hand, one of the outputs of the optical switch SW109 is connected to one of the inputs of the optical switch SW201. Furthermore, the other output of the optical switch SW109 is connected to one of the inputs of the optical switch SW302. The same applies to the other optical switches SW110 to SW112, which constitute the second optical switch group 12.

Additionally, one of the inputs of the optical switch SW201, which constitutes the third optical switch group 13, is connected to one of the outputs of the optical switch SW109. On the other hand, the other input of the optical switch SW201 is connected to one of the outputs of the optical switch SW111. Furthermore, one of the outputs of the optical switch SW201 is connected to one of the inputs of the fifth optical switch SW106. Meanwhile, the other output of the optical switch SW201 is connected to one of the inputs of the fifth optical switch SW102. The same applies to the other optical switches SW202, SW301, and SW302, which constitute the third optical switch group 13.

Additionally, the output of the fifth optical switch SW106 is connected to the third trunk-side upstream trunk line L3Ua. On the other hand, one of the inputs of the fifth optical switch SW106 is connected to one of the outputs of the optical switch SW201. Furthermore, the other input of the fifth optical switch SW106 is connected to one of the outputs of the sixth optical switch SW108. The same applies to the other fifth to eighth optical switches.

As shown in FIG. 2, the first to fourth optical switches (SW1 to SW8) and the optical switch group 10 (SW9 to SW12, SW109 to SW112, SW201, SW202, SW301, SW302) with the above configuration are provided in the first submarine branching unit BU1.

On the other hand, the fifth to eighth optical switches (SW101 to SW108) with the above configuration are provided in the second submarine branching unit BU2. The first submarine branching unit BU1 and the second submarine branching unit BU2 each have a power supply switching function and are connected to each other via connection lines or connection cables, as shown in FIG. 2. The first to fourth optical switches (SW1 to SW8), the fifth to eighth optical switches (SW101 to SW108), and the optical switch group 10 (SW9 to SW12, SW109 to SW112, SW201, SW202, SW301, SW302) are connected to a control unit (not shown) and can be independently switched on and off according to the control from the control unit.

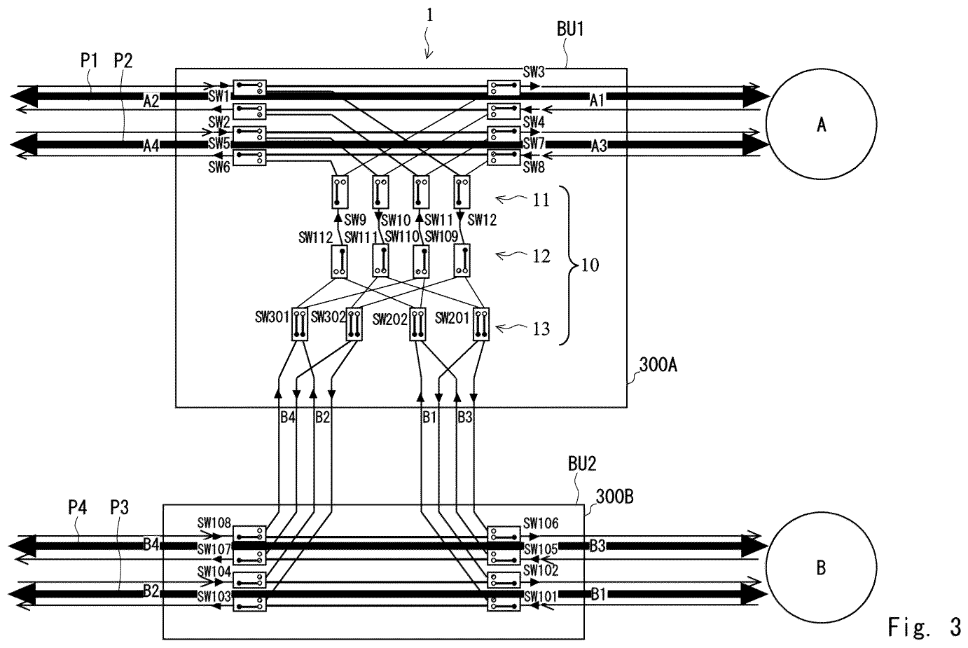

According to the submarine branching unit 1 (submarine cable system) with the above configuration, each optical switch can be independently switched according to the control from the control unit, thereby forming paths 1 to 6 shown in FIGS. 3 to 8. The paths 1 to 6 are examples of the upstream and downstream paths (upward path and downward path) disclosed in the present disclosure.

### Path 1

FIG. 3 is a diagram showing Path 1.

Path 1 includes: two upstream and downstream paths between the first trunk A and the second trunk (not shown), which faces the first trunk A (the upstream and downstream path P1 between A1 and A2, and the upstream and downstream path P2 between A3 and A4 in FIG. 3), and two upstream and downstream paths between the third trunk B and the fourth trunk (not shown), which faces the third trunk B (the upstream and downstream path P3 between B1 and B2, and the upstream and downstream path P4 between B3 and B4 in FIG. 3).

Path 1 (upstream and downstream paths P1 to P4) is configured by switching the first to eighth optical switches (SW1 to SW8, SW101 to SW108) as shown in FIG. 3, where they are switched to the off state, according to the control from the control unit.

### Path 2

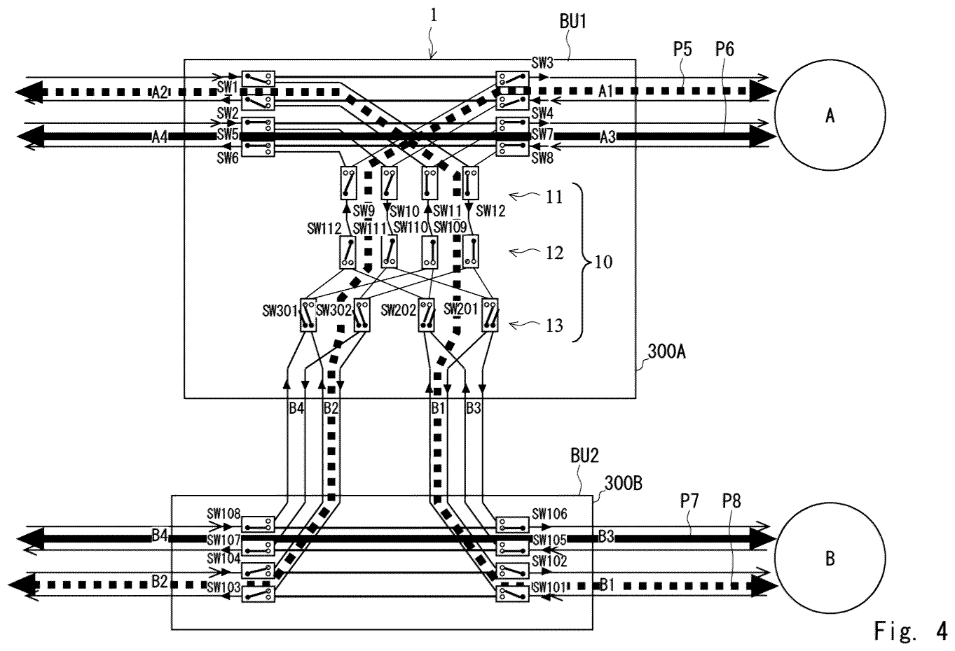

FIG. 4 is a diagram showing Path 2.

Path 2 includes: one upstream and downstream path between the first trunk A and the fourth trunk (not shown), which faces the third trunk B (upstream and downstream path P5 between A1 and B2 in FIG. 4), one upstream and downstream path between the first trunk A and the second trunk (not shown), which faces the first trunk A (upstream and downstream path P6 between A3 and A4 in FIG. 4),

One upstream and downstream path between the third trunk B and the fourth trunk (not shown), which faces the third trunk B (upstream and downstream path P7 between B3 and B4 in FIG. 4), and one upstream and downstream path between the third trunk B and the second trunk (not shown), which faces the first trunk A (upstream and downstream path P8 between B1 and A2 in FIG. 4).

Path 2 (upstream and downstream paths P5 to P8) is configured by switching the first to eighth optical switches (SW1 to SW8, SW101 to SW108) and the optical switch group 10 (SW9 to SW12, SW109 to SW112, SW201, SW202, SW301, SW302) as shown in FIG. 4, according to the control from the control unit.

### Path 3

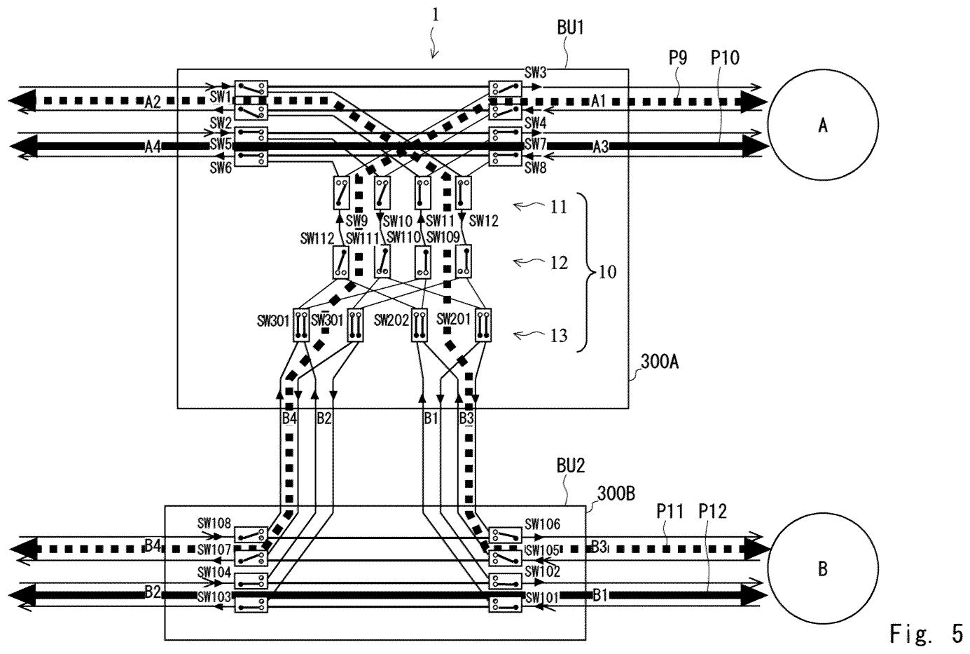

FIG. 5 is a diagram showing Path 3.

Path 3 includes: one upstream and downstream path between the first trunk A and the fourth trunk (not shown), which faces the third trunk B (upstream and downstream path P9 between A1 and B4 in FIG. 5), one upstream and downstream path between the first trunk A and the second trunk (not shown), which faces the first trunk A (upstream and downstream path P10 between A3 and A4 in FIG. 5), One upstream and downstream path between the third trunk B and the second trunk (not shown), which faces the first trunk A (upstream and downstream path P11 between B3 and A2 in FIG. 5), and one upstream and downstream path between the third trunk B and the fourth trunk (not shown), which faces the third trunk B (upstream and downstream path P12 between B1 and B2 in FIG. 5).

Path 3 (upstream and downstream paths P9 to P12) is configured by switching the first to eighth optical switches (SW1 to SW8, SW101 to SW108) and the optical switch group 10 (SW9 to SW12, SW109 to SW112, SW201, SW202, SW301, SW302) as shown in FIG. 5, according to the control from the control unit.

### Path 4

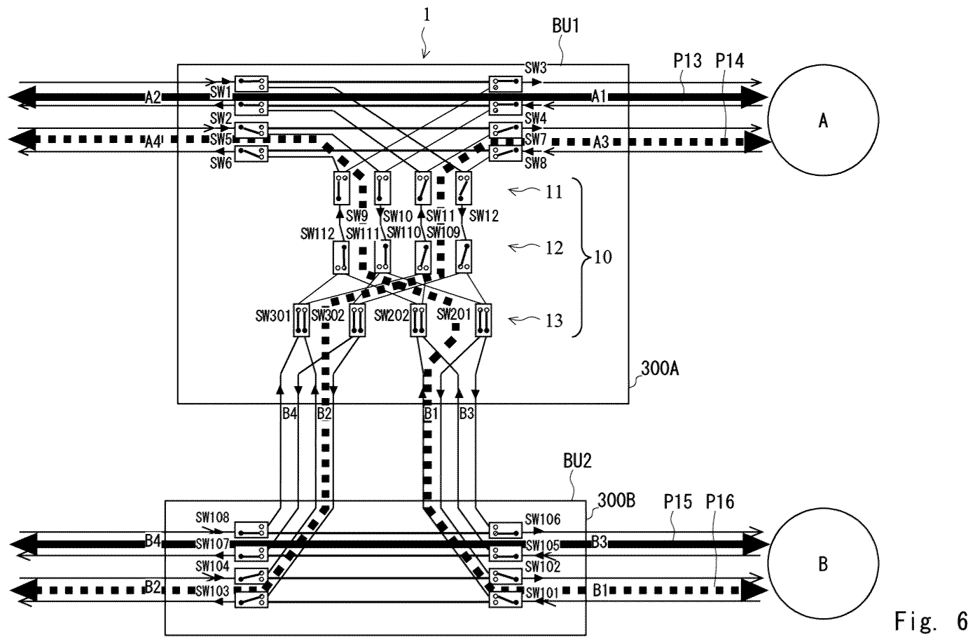

FIG. 6 is a diagram showing Path 4.

Path 4 includes: one upstream and downstream path between the first trunk A and the second trunk (not shown), which faces the first trunk A (upstream and downstream path P13 between A1 and A2 in FIG. 6), one upstream and downstream path between the first trunk A and the fourth trunk (not shown), which faces the third trunk B (upstream and downstream path P14 between A3 and B2 in FIG. 6), one upstream and downstream path between the third trunk B and the fourth trunk (not shown), which faces the third trunk B (upstream and downstream path P15 between B3 and B4 in FIG. 6), and one upstream and downstream path between the third trunk B and the second trunk (not shown), which faces the first trunk A (upstream and downstream path P16 between B1 and A4 in FIG. 6).

Path 4 (upstream and downstream paths P13 to P16) is configured by switching the first to eighth optical switches (SW1 to SW8, SW101 to SW108) and the optical switch group 10 (SW9 to SW12, SW109 to SW112, SW201, SW202, SW301, SW302) as shown in FIG. 6, according to the control from the control unit.

### Path 5

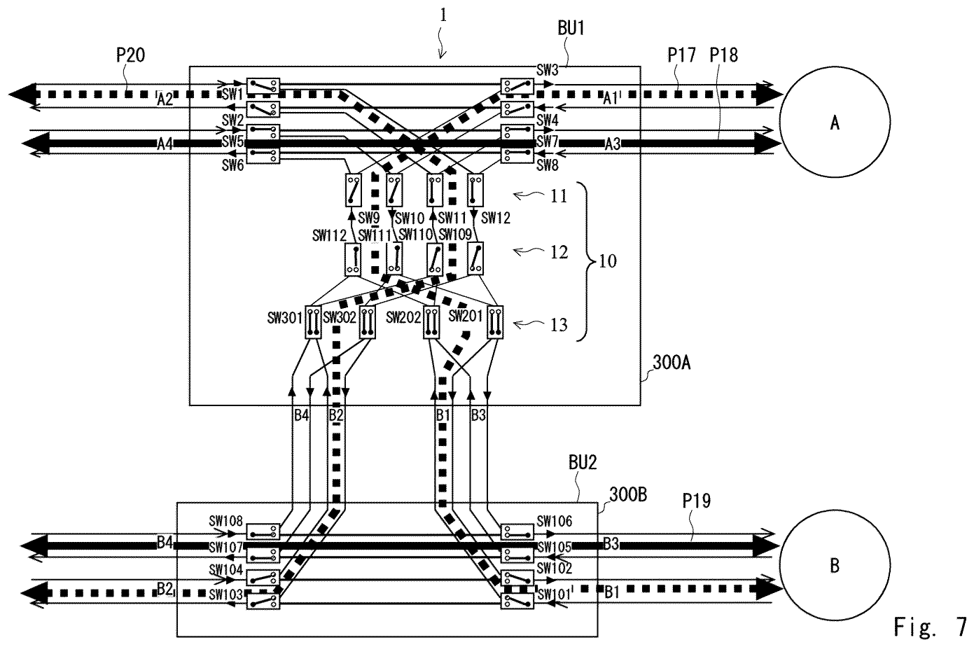

FIG. 7 is a diagram showing Path 5.

Path 5 includes: one upstream and downstream path between the first trunk A and the third trunk B (upstream and downstream path P17 between A1 and B1 in FIG. 7), one upstream and downstream path between the first trunk A and the second trunk (not shown), which faces the first trunk A (upstream and downstream path P18 between A3 and A4 in FIG. 7), one upstream and downstream path between the third trunk B and the fourth trunk (not shown), which faces the third trunk B (upstream and downstream path P19 between B3 and B4 in FIG. 7), and one upstream and downstream path between the fourth trunk (not shown), which faces the third trunk B, and the second trunk (not shown), which faces the first trunk A (upstream and downstream path P20 between B2 and A2 in FIG. 7).

Path 5 (upstream and downstream paths P17 to P20) is configured by switching the first to eighth optical switches (SW1 to SW8, SW101 to SW108) and the optical switch group 10 (SW9 to SW12, SW109 to SW112, SW201, SW202, SW301, SW302) as shown in FIG. 7, according to the control from the control unit.

### Path 6

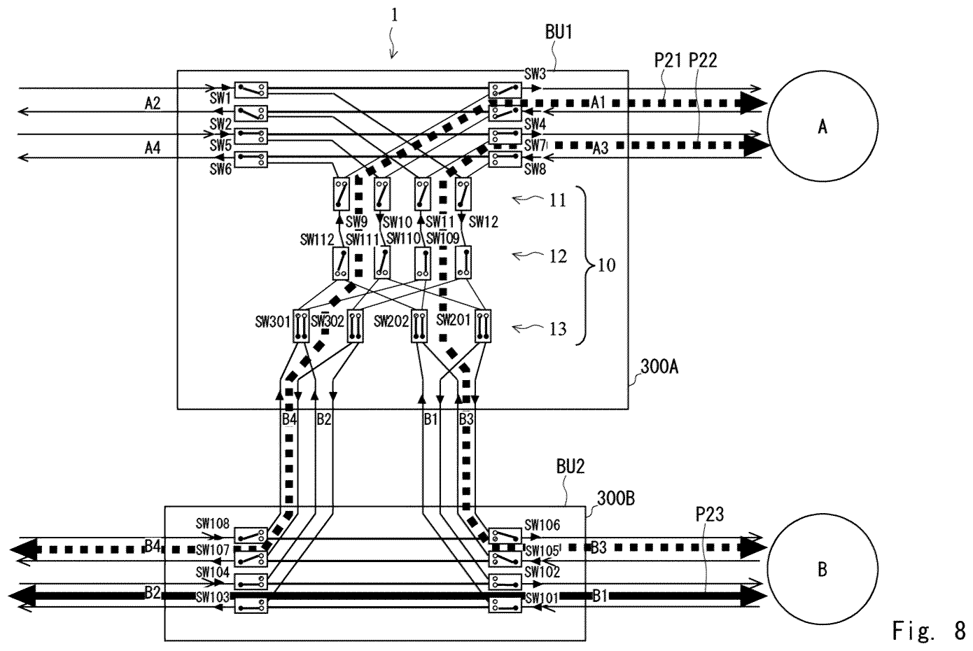

FIG. 8 is a diagram showing Path 6.

Path 6 includes: one upstream and downstream path between the first trunk A and the fourth trunk (not shown), which faces the third trunk B (upstream and downstream path P21 between A1 and B4 in FIG. 8), one upstream and downstream path between the first trunk A and the third trunk B (upstream and downstream path P22 between A3 and B3 in FIG. 8), and one upstream and downstream path between the third trunk B and the fourth trunk (not shown), which faces the third trunk B (upstream and downstream path P23 between B1 and B2 in FIG. 8).

Path 6 (upstream and downstream paths P21 to P23) is configured by switching the first to eighth optical switches (SW1 to SW8, SW101 to SW108) and the optical switch group 10 (SW9 to SW12, SW109 to SW112, SW201, SW202, SW301, SW302) as shown in FIG. 8, according to the control from the control unit.

As described above, according to the second embodiment, by controlling the first to eighth optical switches (SW1 to SW8, SW101 to SW108) and the optical switch group 10 (SW9 to SW12, SW109 to SW112, SW201, SW202, SW301, SW302) in accordance with the control from the control unit 20, it is possible to interconnect the trunks of two different systems (the first system-side trunk line pairs L1 and L2, and the second system-side trunk line pairs L3 and L4) and enable mutual communication.

Furthermore, according to the second embodiment, it is possible to form various paths (e.g., Path 1 to Path 6) between the trunks of two different systems (between the first system-side trunk line pairs L1 and L2, and the second system-side trunk line pairs L3 and L4).

Furthermore, according to the second embodiment, it is possible to connect a different system to the branch side, which is typically a cable landing station.

Furthermore, according to the second embodiment, since the trunks between two mutually different systems (between the first system-side trunk line pairs L1 and L2, and the second system-side trunk line pairs L3 and L4) can be flexibly interconnected, there is also an advantage of enhancing the communication range.

### Hardware Configuration

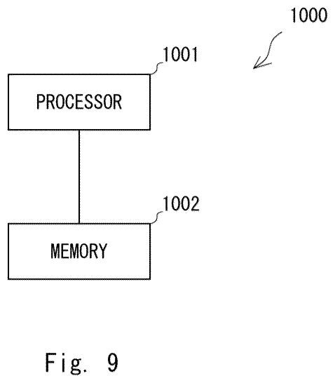

FIG. 9 is a block diagram illustrating an example of the configuration of computer 1000 according to the present embodiment. Each device of the submarine branching unit 1 (submarine cable system) described above (first submarine branching unit BU1, second submarine branching unit BU2, and control device) is implemented by computer 1000. As shown in FIG. 9, computer 1000 includes a processor 1001, memory 1002, and network interface 1003. The network interface 1003 may be used to communicate with a network node.

The network interface 1003 may include, for example, a network interface card (NIC) compliant with the IEEE 802.3 series. IEEE stands for Institute of Electrical and Electronics Engineers. The processor 1001 reads one or more programs from memory 1002, which include a set of instructions to execute the algorithm (method) described using the drawings, and executes the read program. The processor 1001 may be, for example, a microprocessor, MPU, or CPU. The processor 1001 may also include multiple processors.

The memory 1002 consists of a combination of volatile memory and non-volatile memory. The memory 1002 stores programs. Additionally, the memory 1002 may include storage that is located separately from the processor 1001.

In this case, the processor 1001 may access the memory 1002 via an I/O (Input/Output) interface (not shown).

In the above example, when the program is loaded into the computer, it includes a set of instructions (or software code) to enable the computer to perform one or more functions described in the embodiment. The program may be stored in a non-transitory computer-readable medium or a tangible storage medium. As non-limiting examples, the computer-readable medium or tangible storage medium includes random-access memory (RAM), read-only memory (ROM), flash memory, solid-state drive (SSD), or other memory technologies; CD-ROM, digital versatile disc (DVD), Blu-ray™ disc, or other optical disc storage; magnetic cassette, magnetic tape, magnetic disk storage, or other magnetic storage devices. The program may also be transmitted over a transitory computer-readable medium or a communication medium. As non-limiting examples, the transitory computer-readable medium or communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

It should be noted that the present disclosure is not limited to the above-described embodiments and may be appropriately modified without departing from the spirit of the present disclosure.

It should be noted that the present disclosure is not limited to the above-described embodiments and may be appropriately modified without departing from the spirit of the present disclosure.

Some or all of the above-described embodiments may also be described as follows in the appendix, but are not limited thereto.

### Supplementary Note 1

A submarine branching unit, comprising:
two first system-side trunk line pairs that are arranged in parallel between a first trunk and a second trunk;
two second system-side trunk line pairs that are arranged in parallel between a third trunk and a fourth trunk; and
an optical switch group configured to switch the connection state between the first system-side trunk line pairs and the second system-side trunk line pairs in accordance with control from a control unit.

### Supplementary Note 2

The submarine branching unit according to supplementary note 1, wherein

the first system-side trunk line pairs comprise a first system-side upstream trunk line and a first system-side downstream trunk line, the second system-side trunk line pairs comprise a second system-side upstream trunk line and a second system-side downstream trunk line, the first system-side upstream trunk line includes a first trunk-side upstream trunk line, a first intermediate upstream trunk line, a second trunk-side upstream trunk line, a first optical switch configured to switch the connection between the first trunk-side upstream trunk line and the first intermediate upstream trunk line or the optical switch group, and a second optical switch configured to switch the connection between the second trunk-side upstream trunk line and the first intermediate upstream trunk line or the optical switch group, the first system-side downstream trunk line includes a first trunk-side downstream trunk line, a first intermediate downstream trunk line, a second trunk-side downstream trunk line, a third optical switch configured to switch the connection between the first trunk-side downstream trunk line and the first intermediate downstream trunk line or the optical switch group, and a fourth optical switch configured to switch the connection between the second trunk-side downstream trunk line and the first intermediate downstream trunk line or the optical switch group, the second system-side upstream trunk line includes a third trunk-side upstream trunk line, a second intermediate upstream trunk line, a fourth trunk-side upstream trunk line, a fifth optical switch configured to switch the connection between the third trunk-side upstream trunk line and the second intermediate upstream trunk line or the optical switch group, and a sixth optical switch configured to switch the connection between the fourth trunk-side upstream trunk line and the second intermediate upstream trunk line or the optical switch group, the second system-side downstream trunk line includes a third trunk-side downstream trunk line, a second intermediate downstream trunk line, a fourth trunk-side downstream trunk line, a seventh optical switch configured to switch the connection between the third trunk-side downstream trunk line and the second intermediate downstream trunk line or the optical switch group, and an eighth optical switch configured to switch the connection between the fourth trunk-side downstream trunk line and the second intermediate downstream trunk line or the optical switch group, and based on the switching states of each of the first to eighth optical switches and the optical switch group, an upstream trunk line and a downstream trunk line are formed between two of the first trunk, the second trunk, the third trunk, and the fourth trunk.

### Supplementary Note 3

The submarine branching unit according to supplementary note 2, wherein

the first to eighth optical switches are controlled so that two upstream and downstream paths are formed between the first trunk and the second trunk, and two upstream and downstream paths are formed between the third trunk and the fourth trunk.

### Supplementary Note 4

The submarine branching unit according to supplementary note 2, wherein

the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the fourth trunk, and one upstream and downstream path is formed between the third trunk and the second trunk.

### Supplementary Note 5

The submarine branching unit according to supplementary note 2, wherein

the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the second trunk, and one upstream and downstream path is formed between the third trunk and the fourth trunk.

### Supplementary Note 6

The submarine branching unit according to supplementary note 2, wherein

the first to eighth optical switches and the optical switch group are controlled so that one upstream and downstream path is formed between the first trunk and the second trunk, one upstream and downstream path is formed between the first trunk and the fourth trunk, one upstream and downstream path is formed between the third trunk and the fourth trunk, and one upstream and downstream path is formed between the third trunk and the second trunk.

### Supplementary Note 7

The submarine branching unit according to supplementary note 2, wherein

the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the fourth trunk, and one upstream and downstream path is formed between the fourth trunk and the second trunk.

### Supplementary Note 8

The submarine branching unit according to supplementary note 2, wherein

the first to eighth optical switches and the optical switch group are controlled so that one upstream and downstream path is formed between the first trunk and the fourth trunk, one upstream and downstream path is formed between the first trunk and the third trunk, and one upstream and downstream path is formed between the third trunk and the fourth trunk.

### Supplementary Note 9

The submarine branching unit according to supplementary note 2, wherein

the optical switch group includes a first optical switch group, a second optical switch group, and a third optical switch group, which are arranged in parallel, the first to fourth optical switches are connected to the first optical switch group, the first optical switch group is connected to the second optical switch group, the second optical switch group is connected to the third optical switch group, and the fifth to eighth optical switches are connected to the third optical switch group.

### Supplementary Note 10

The submarine branching unit according to supplementary note 9, wherein

the first to eighth optical switches, the first optical switch group, and the second optical switch group are each 1×2 optical switches.

### Supplementary Note 11

The submarine branching unit according to supplementary note 10, wherein the third optical switch group is a 2×2 optical switch.

### Supplementary Note 12

The submarine branching unit according to supplementary note 2, further comprising: a first submarine branching unit in which the first to fourth optical switches and the optical switch group are provided; and a second submarine branching unit in which the fifth to eighth optical switches are provided.

What is claimed is:

1. A submarine branching unit, comprising:
two first system-side trunk line pairs that are arranged in parallel between a first trunk and a second trunk;
two second system-side trunk line pairs that are arranged in parallel between a third trunk and a fourth trunk; and
an optical switch group configured to switch the connection state between the first system-side trunk line pairs and the second system-side trunk line pairs in accordance with control from a control unit.

2. The submarine branching unit according to claim 1, wherein the first system-side trunk line pairs comprise a first system-side upstream trunk line and a first system-side downstream trunk line, the second system-side trunk line pairs comprise a second system-side upstream trunk line and a second system-side downstream trunk line, the first system-side upstream trunk line comprises a first trunk-side upstream trunk line, a first intermediate upstream trunk line, a second trunk-side upstream trunk line, a first optical switch configured to switch the connection between the first trunk-side upstream trunk line and the first intermediate upstream trunk line or the optical switch group, and a second optical switch configured to switch the connection between the second trunk-side upstream trunk line and the first intermediate upstream trunk line or the optical switch group, the first system-side downstream trunk line comprises a first trunk-side downstream trunk line, a first intermediate downstream trunk line, a second trunk-side downstream trunk line, a third optical switch configured to switch the connection between the first trunk-side downstream trunk line and the first intermediate downstream trunk line or the optical switch group, and a fourth optical switch configured to switch the connection between the second trunk-side downstream trunk line and the first intermediate downstream trunk line or the optical switch group, the second system-side upstream trunk line comprises a third trunk-side upstream trunk line, a second intermediate upstream trunk line, a fourth trunk-side upstream trunk line, a fifth optical switch configured to switch the connection between the third trunk-side upstream trunk line and the second intermediate upstream trunk line or the optical switch group, and a sixth optical switch configured to switch the connection between the fourth trunk-side upstream trunk line and the second intermediate upstream trunk line or the optical switch group, the second system-side downstream trunk line comprises a third trunk-side downstream trunk line, a second intermediate downstream trunk line, a fourth trunk-side downstream trunk line, a seventh optical switch configured to switch the connection between the third trunk-side downstream trunk line and the second intermediate downstream trunk line or the optical switch group, and an eighth optical switch configured to switch the connection between the fourth trunk-side downstream trunk line and the second intermediate downstream trunk line or the optical switch group, and based on the switching states of each of the first to eighth optical switches and the optical switch group, an upstream trunk line and a downstream trunk line are formed between two of the first trunk, the second trunk, the third trunk, and the fourth trunk.

3. The submarine branching unit according to claim 2, wherein the first to eighth optical switches are controlled so that two upstream and downstream paths are formed between the first trunk and the second trunk, and two upstream and downstream paths are formed between the third trunk and the fourth trunk.

4. The submarine branching unit according to claim 2, wherein the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the fourth trunk, and one upstream and downstream path is formed between the third trunk and the second trunk.

5. The submarine branching unit according to claim 2, wherein the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the second trunk, and one upstream and downstream path is formed between the third trunk and the fourth trunk.

6. The submarine branching unit according to claim 2, wherein the first to eighth optical switches and the optical switch group are controlled so that one upstream and downstream path is formed between the first trunk and the second trunk, one upstream and downstream path is formed between the first trunk and the fourth trunk, one upstream and downstream path is formed between the third trunk and the fourth trunk, and one upstream and downstream path is formed between the third trunk and the second trunk.

7. The submarine branching unit according to claim 2, wherein the first to eighth optical switches and the optical switch group are controlled so that one upstream and downstream path is formed between the first trunk and the fourth trunk, one upstream and downstream path is formed between the first trunk and the second trunk, one upstream and downstream path is formed between the third trunk and the fourth trunk, and one upstream and downstream path is formed between the fourth trunk and the second trunk.

8. The submarine branching unit according to claim 2, wherein the first to eighth optical switches and the optical switch group are controlled so that one upstream and downstream path is formed between the first trunk and the fourth trunk, one upstream and downstream path is formed between the first trunk and the third trunk, and one upstream and downstream path is formed between the third trunk and the fourth trunk.

9. The submarine branching unit according to claim 2, wherein the optical switch group includes a first optical switch group, a second optical switch group, and a third optical switch group, which are arranged in parallel, the first to fourth optical switches are connected to the first optical switch group, the first optical switch group is connected to the second optical switch group, the second optical switch group is connected to the third optical switch group, and the fifth to eighth optical switches are connected to the third optical switch group.

10. The submarine branching unit according to claim 9, wherein the first to eighth optical switches, the first optical switch group, and the second optical switch group are each 1×2 optical switches.
